(19) United States
(12) Patent Application Publication
(10) Pub. No.: US 2014/0074545 A1
(43) Pub. Date: Mar. 13, 2014

(54) HUMAN WORKFLOW AWARE RECOMMENDATION ENGINE

(71) Applicant: Magnet Systems Inc., Palo Alto, CA (US)

(72) Inventors: Kevin A. MINDER, Medford, NJ (US); Robyn J. CHAN, San Francisco, CA (US); Hanju KIM, Palo Alto, CA (US)

(73) Assignee: MAGNET SYSTEMS INC., Palo Alto, CA (US)

(21) Appl. No.: 13/844,114

(22) Filed: Mar. 15, 2013

Related U.S. Application Data
(60) Provisional application No. 61/698,514, filed on Sep. 7, 2012.

(51) Int. Cl. G06Q 10/06

(52) U.S. Cl. CPC G06Q 10/0633
USPC 705/7.27

(57) ABSTRACT

Recommendation systems and processes for generating recommendations within the context of a socially-enabled human workflow system are provided. The processes may include accessing workflow data, such as social graphs, organization graphs, collaboration graphs, content data, utilization data, ratings data, and the like, associated with a user requesting a recommendation. The process may further include determining one or more of a user similarity score, task similarity score, goal similarity score, and content similarity score. The process may further include generating one or more recommendations based at least in part on one or more of the user similarity score, task similarity score, goal similarity score, and content similarity score.

### CROSS-REFERENCE TO RELATED APPLICATIONS

This application claims priority to U.S. Provisional Patent Application Ser. No. 61/698,514, filed Sep. 7, 2012, the entire disclosure of which is hereby incorporated by reference in its entirety for all purposes as if put forth in full below.

### BACKGROUND

1. Field

The present disclosure relates to providing recommendations and, in one particular example, to providing recommendations for user workflows.

2. Related Art

In the information age, people often struggle with an overload of information. For example, in the context of user workflows, a user is often required to manually filter through irrelevant or low-value information in order to determine what is required to complete a task. This may reduce a user's ability to make decisions and perform tasks efficiently.

To help users navigate the large volumes of information, recommendation engines have been developed. However, existing recommendation engines are based on very narrow views of a user's context and do not take into consideration social and workflow information. For example, conventional recommendation engines may provide product recommendations for a specific user searching for a specific type of product. However, these recommendation engines do not consider the task the user is trying to accomplish or the relationships between the user and other users that may have searched for similar products or that may have performed similar tasks. As a result of conventional recommendation engines' limited view of the context within which the user is performing the search, they cannot provide sufficiently targeted information.

Thus, what is desired is a recommendation system that provides customized collections of information that relate both to the context in which the user is operating and the time at which the user requires the information.

### SUMMARY

Recommendation systems and processes for generating recommendations within the context of a socially enabled human workflow system are disclosed. The process may include receiving a request for a recommendation from a computing device of a user. The process may further include determining user similarity scores between the user and other users as well as contextual similarity scores between a context of the user and contexts of a plurality of items. A first set of recommended items may be generated based on the user similarity scores and a second set of recommended items may be generated based on the contextual similarity scores. A weighted average of scores associated with the items in the first and second sets of recommended items may be determined to generate one or more recommendations for the user. The one or more recommendations may then be transmitted to the computing device of the user.

### BRIEF DESCRIPTION OF THE FIGURES

The present application may be best understood by reference to the following description taken in conjunction with the accompanying drawing figures, in which like parts may be referred to by like numerals.

FIG. 1 illustrates an exemplary system for generating recommendations according to various embodiments.

FIG. 2 illustrates an exemplary process for generating recommendations according to various embodiments.

FIG. 3 illustrates an exemplary process for determining user and contextual similarity according to various embodiments.

FIG. 4 illustrates an exemplary social graph according to various embodiments.

FIG. 5 illustrates an exemplary organization graph according to various embodiments.

FIG. 6 illustrates an exemplary process for extracting and aggregating recommendation data according to various embodiments.

FIG. 7 illustrates an exemplary user interface for a recommendation engine according to various embodiments.

FIG. 8 illustrates another exemplary user interface for a recommendation engine according to various embodiments.

FIG. 9 illustrates an exemplary computing system that may be used to carry out the various embodiments described herein.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

Various examples are described below relating to recommendation engines and processes for generating recommendations within the context of a socially enabled human workflow system. The process may include receiving a request for a recommendation from a computing device of a user. The process may further include determining user similarity scores between the user and other users as well as contextual similarity scores between a context of the user and contexts of a plurality of items. A first set of recommended items may be generated based on the user similarity scores and a second set of recommended items may be generated based on the contextual similarity scores. A weighted average of scores associated with the items in the first and second sets of recommended items may be determined to generate one or more recommendations for the user. The one or more recommendations may then be transmitted to the computing device of the user.

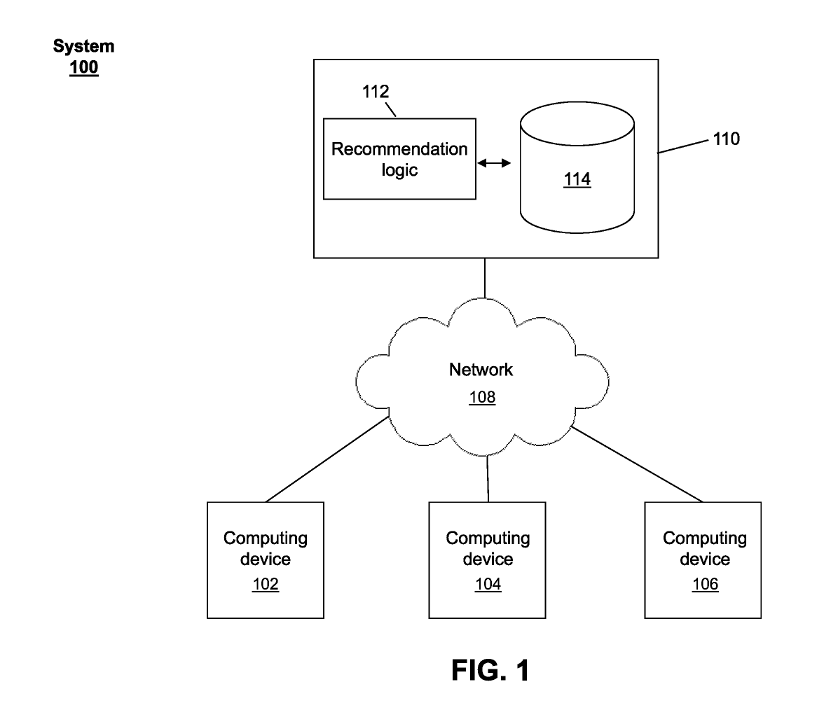

FIG. 1 illustrates an exemplary system 100 for generating recommendations according to various embodiments. Generally, system 100 may include computing devices 102, 104, and 106 that may communicate with each other and/or server 110 via network 108. Server 110 may include recommendation logic 112 for generating recommendations and a local and/or remote database 114. Server 110 and computing devices 102, 104, and 106 may include any one of various types of computing devices having, for example, a processing unit, a memory (including a permanent storage device), and a communication interface, as well as other conventional computer components (e.g., an input device, such as a keyboard and mouse, and an output device, such as a display). For example, computing devices 102, 104, and 106 may include any type of computing device, such as a mobile phone, laptop, tablet, desktop computer, or the like. While three computing devices are shown, it should be appreciated that system 100 may include any number of computing devices.

Server 110 and computing devices 102, 104, and 106 may communicate, for example, using suitable communication interfaces via network 108, such as the Internet, a LAN, a WAN, or the like. Server 110 and computing devices 102, 104, and 106 may communicate, in part or in whole, via wireless or hardwired communications, such as Ethernet, IEEE 802.11a/b/g/n/ac wireless, or the like. Additionally, communication between computing devices 102, 104, and 106 and server 110 may include various servers, such as a mobile server or the like.

Each computing device 102, 104, and 106 may be associated with one or more users. Through these devices, associated users may create content, create tasks, and be assigned tasks. In some examples, users may be registered with the system such that information relating to their activity within the system may be collected to drive recommendations. For example, users may create a profile to be stored by server 110 in database 114.

In some examples, computing devices 102, 104, and 106 may be configured to monitor or determine the mode of a user. A mode may include the context of the user at a point in time at which an action was performed. The context of the user may include a location of the user, activity of the user, time of day/week/month/year, type of computing device used by the user, or any other data describing the context (e.g., environment or setting) associated with the user. These may be application dependent, but typically may be a collection of weighted categories. For example, at a given point in time, a user may be 100% mobile, 25% work, and 75% social. This may be interpreted as the user traveling with friends, but checking work email occasionally. The computing devices 102, 104, and 106 may determine the mode of a user in a variety of ways. For example, actions of the user, a location of the user, time of day/week/month/year, applications running on the device, and the like may be monitored by the device to determine a mode of the user. The mode determined by computing devices 102, 104, and 106 may be transmitted to server 110 via network 108 to be stored in database 114 and accessed by recommendation logic 112.

Server 110 may include or access recommendation logic 112 and database 114. In some examples, database 114 may include a local and/or remote storage device for storing various types of items, such as user data, content data, workspace data, workflow data, task data, and the like. This data may be provided to server 110 from users associated with computing devices 102, 104, and 106 or may be entered into database 114 by an administrator or owner of system 100.

One type of data that may be stored in database 114 is content. Content generally includes any information that is entered into the system, such as documents, user profiles, text documents, images, forms, blogs, comments, polls, invitations, calendar entries, and the like. There are many sub-types of content and users may create new types. In some examples, server 110 may extract key phrases from the content for use by recommendation logic 112. The content may be structured (e.g., RDBMS tables/rows) or unstructured (e.g., text documents).

Another type of data that may be stored in database 114 is a workflow. A workflow may generally include a description or template that describes work that needs to be performed to accomplish a goal. A workflow may be separated into two categories: complex and simple. A complex workflow may include a description of a multi-step process that may include branching and decision logic that may be followed to accomplish a goal. In a complex workflow, required users and content to perform the steps may be identified abstractly by the roles they fulfill within the workflow. For example, a required user may be identified by a title or a task that a user is capable of performing. Similarly, required content may include an identifier describing a type of document required. A simple workflow may include a single unit of work that may be used to accomplish a sub-goal in a complex workflow. In a simple workflow, required users and content may also be identified abstractly by role and may be inherited from the complex workflow that it is included within.

Another type of data that may be stored in database 114 is a task. A task may include a populated manifestation of a workflow and the status of the work required by the workflow. In other words, a task is the per-instance manifestation of a workflow. Thus, a task may include references to preceding tasks, identities of the users and contents selected (e.g., selected by a user) to fulfill each role in the workflow, text associated with the task (e.g., a text description of the task to be completed), the identity of an issuer of the task, identifiers of associated workflows, target user(s) assigned to the task, or the like. For example, a workflow may describe a process for reviewing a document. The workflow may abstractly identify a user issuing the task, a user assigned to perform the task, a document to be reviewed, and the steps to be performed to review the document. The task may include an identification of the actual issuer of the task, an identification of the actual user assigned to perform the task, an identification of the actual document to be reviewed, and the steps to be performed to review the document.

Another type of data that may be stored in database 114 is a social graph. The social graph may include interconnected nodes, where each node represents a user and the connecting edges represent relationships between these users. The relationship may be defined by different relationship types, such as friend, co-worker, classmate, etc., and may be defined by the associated edge within the social graph.

Another type of data that may be stored in database 114 is an organization graph. Similar to the social graph, an organization graph may include interconnected nodes, where each node represents a user and the connecting edges represent relationships between these users. However, in an organization graph, the users may be users within a particular organization and the edges may represent structured relationships between these users within the organization. For example, an organization graph for a company may include nodes representing employees and edges representing manager/subordinate/peer relationships between the employees.

Another type of data that may be stored in database 114 is a collaboration graph. Similar to the social and organization graphs, a collaboration graph may include interconnected nodes, where each node represents a user and the connecting edges represent relationships between these users. However, the collaboration graph may instead track and document interactions between users of system 100 as they collaborate to accomplish shared goals. In some examples, the collaboration graph may be generated based on users being members of a workspace and/or based on users being assigned roles or otherwise participating in a workflow task.

Another type of data that may be stored in database 114 is the utilization of a user or content. In particular, system 100 may collect, on a per-user basis, information about user interactions with other users and with content, including frequency and time of the interaction. Each recorded interaction may include the user's mode at the time of the interaction.

Another type of data that may be stored in database 114 is a rating of a user, content, or workflow. These ratings may be entered by users and stored on a per-user basis. Other ratings may be collected and stored without user input. For example, a task may be rated according to success criteria, such as the time required for completion.

Using the data stored in database 114 described above, server 110 may create and track relationships between items, such as users, tasks, content, and the like. This essentially represents tracking the creation and utilization of content. Server 110 may further generate workspaces for users. These workspaces include logical meeting places where users may share information that applies to a shared task.

Server 110 may further track tasks and workflows assigned to users associated with computing devices 102, 104, and 106. For example, a user associated with computing device 102 may want to assign a task to a user associated with computing device 104. To do so, the user of computing device 102 may send task data associated with the task to server 110 via network 108. Server 110 may process the task assignment by storing the task data within database 114 and forwarding the task data to computing device 104 via network 108. Additionally, server 110 may be used to receive workflow data associated with a particular user. For example, a user of computing device 106 may want to send a request to server 110 via network 108 to receive workflow data associated with the user. Server 110 may access database 114 to retrieve workflow data associated with the user (e.g., by using a username/password) and may transmit the retrieved workflow data to computing device 106 via network 108.

Server 110 may be further programmed to format data, accessed from local or remote databases or other sources of data, for presentation to users of computing devices 102, 104, and 106, preferably in the format discussed in detail herein. Server 110 may utilize various Web data interface techniques such as Common Gateway Interface (CGI) protocol and associated applications (or “scripts”), Java® “servlets” (i.e., Java applications running on the Web server), an application that utilizes Software Development Kit Application Programming Interfaces (“SDK APIs”), or the like to present information and receive input from computing devices 102, 104, and 106. Server 110, although described herein in the singular, may actually include multiple computers, devices, backends, and the like, communicating (wired and/or wirelessly) and cooperating to perform the functions described herein.

It will be recognized that, in some examples, individually shown devices may comprise multiple devices and be distributed over multiple locations. Further, various additional servers and devices may be included such as Web servers, media servers, mail servers, mobile servers, advertisement servers, and the like as will be appreciated by those of ordinary skill in the art.

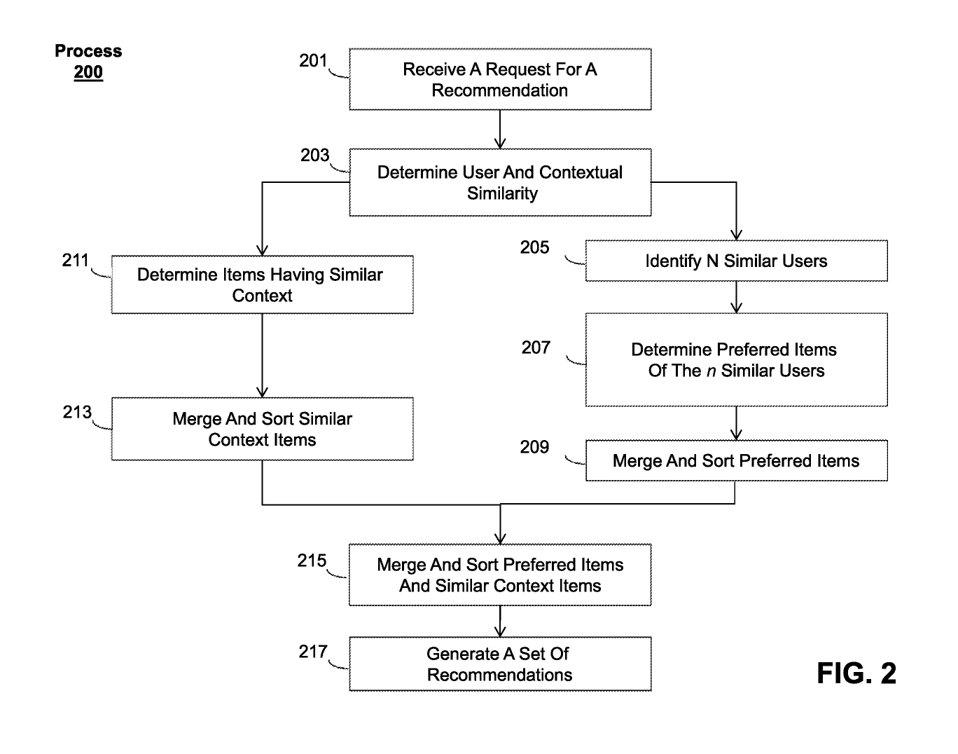

FIG. 2 illustrates an exemplary process 200 that may be performed to generate recommendations. In some examples, process 200 may be performed by a computing device, such as server 110, programmed with recommendation logic, such as recommendation logic 112, within a computing environment similar or identical to system 100.

At block 201, a request for a recommendation may be received. The recommendation may be received by a computing device (e.g., server 110 of FIG. 1) via a wired or wireless network (e.g., network 108 of FIG. 1) from a computing device associated with a user (e.g., computing device 102, 104, or 106 of FIG. 1). The request may include an identification of the user making the request, the context of the user, a requested item (e.g., user, content, workspace, workflow, task, etc.), other search parameters (e.g., search strings, etc.), or the like. It should be appreciated that the request need not be explicitly made by the user. For example, a user may access a document, and a request for a recommendation based on the requested document may automatically be made.

At block 203, user and contextual similarity may be determined. A computing device, such as server 110, programmed with recommendation logic, such as recommendation logic 112, may determine the user and contextual similarity based on information received from the requesting user at block 201 and data associated with items, such as users, content, workspaces, workflows, tasks, and the like, stored in a local or remote database (e.g., database 114).

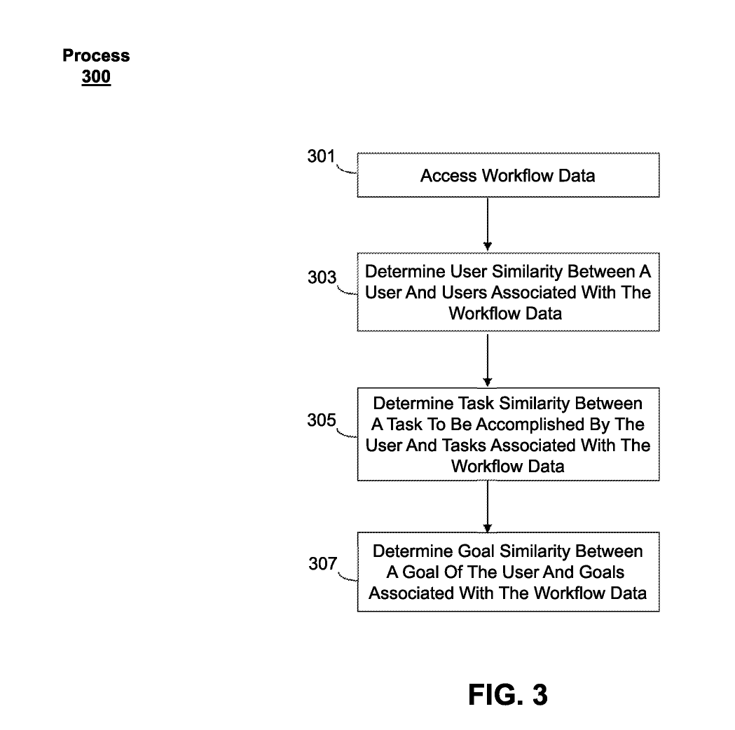

In some examples, an exemplary process 300, shown in FIG. 3, may be used to determine the user and contextual similarity. Process 300 may be performed by a computing device, such as server 110, programmed with recommendation logic, such as recommendation logic 112, within a computing environment similar or identical to system 100.

At block 301, workflow data may be accessed. In some examples, the data may be accessed from a local or remote workflow database similar or identical to database 114 of FIG. 1. The workflow data may include social graphs, organization graphs, collaboration graphs, content data, utilization data, ratings data, workflow data, task data, goal data, and the like, associated with users tracked by the system.

At block 303, user similarity may be determined between the user requesting a recommendation at block 201 and users associated with the workflow data. For example, if a recommendation is to be made for user A, user similarities may be determined between user A and other users being tracked by the recommendation system 100 whose data is included within the workflow data. The user similarity may be determined using one or more of social similarity, organizational similarity, contextual similarity, and preference similarity.

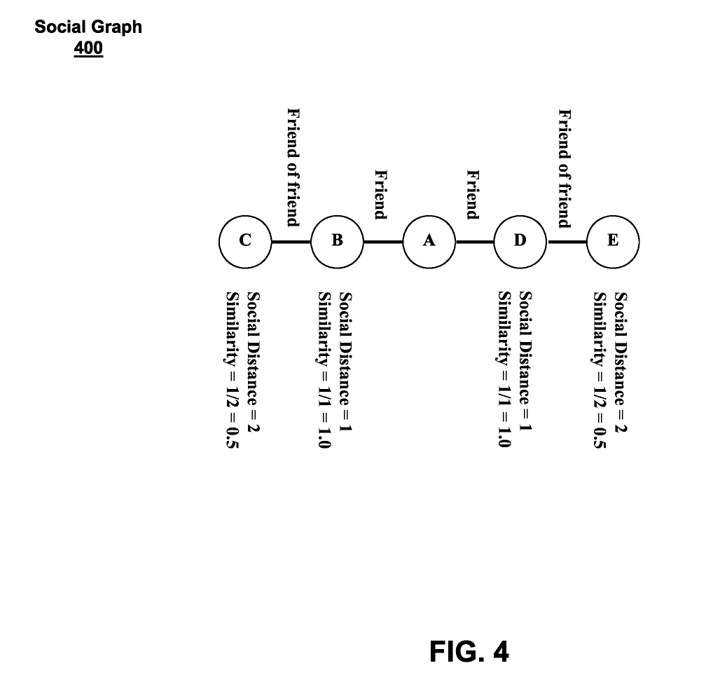

Social similarity is based on the concept that a user is likely to have needs and preferences similar to those of friends. Additionally, a user is more likely to have similar needs and preferences to a closely related user (e.g., a friend) than a more distantly related user (e.g., a friend of a friend). To determine social similarity, distances between users in a social graph accessed from a database at block 201 may be determined. For example, FIG. 4 shows a social graph 400 for user A. As shown, social graph 400 includes nodes corresponding to users A, B, C, D, and E and edges indicating the type of relationships existing between the users and user A. In particular, social graph 400 indicates that users D and B are friends of user A, while users C and E are friends of friends of user A. In one example, to determine social similarity, the inverse of social distance may be used. The social distance between two users represents the number of edges that must be traversed along the shortest path to move from the node of one user to another. For example, the social distance between users A and D is one, since only a single edge must be traversed to get from node A to node D. This equates to a social similarity value of 1 (similarity=1/1). In contrast, the social distance between users A and E is two, since two edges (A to D and D to E) must be traversed to get from node A to node E. This equates to a social similarity value of 0.5 (similarity=1/2). Thus, users A and D are more similar than users A and E.

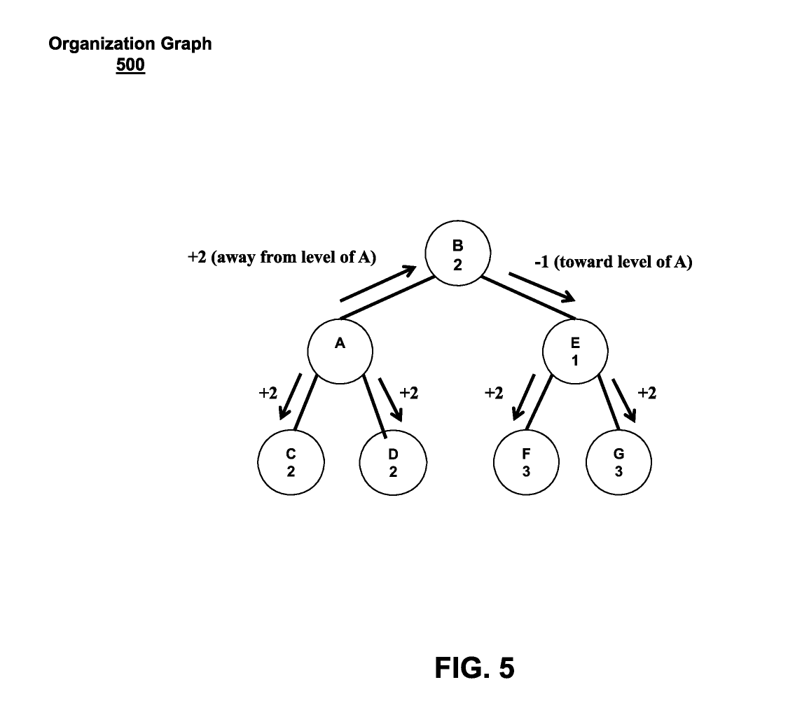

Organizational similarity may be based on the concept that a user is likely to have needs and preferences similar to others in the same group or those that are organizationally near. Similar to determining social similarity, distances between users in an organization graph accessed from a database at block 301 may be determined. However, since organization graphs take the form of a tree, different algorithms for computing similarity may be used. The result of these algorithms may indicate that users that are organizationally near have a higher value for this metric. For example, FIG. 5 illustrates an organization graph 500 for user A. Organization graph 500 includes nodes corresponding to users A, B, C, D, E, F, and G and edges indicating relationships between the users and user A. To determine organizational similarity, the inverse of organizational distance may be used. Organizational distance may be determined by starting with an organization distance of zero and increasing the distance value by 2 for each vertical traversal extending away from the level of the source user and reducing the distance value by 1 for each vertical traversal that moves toward the level of the source user. For example, if user A is the source user, the distance between user A and user A's manager (user B) is two because a vertical traversal extending away from the level of user A is needed to reach user B, indicating that user A and user B are fairly similar. This equates to an organizational similarity value of 0.5 (similarity=1/2). Similarly, the distance between user A and user A's subordinates (users C and D) is 2 because a vertical traversal extending away from the level of A is needed to reach users C and D, likewise indicating that user A is fairly similar to users C and D. In contrast, user A and user A's peer (user E) have a distance value of 1 since a vertical traversal away from user A's level (+2) toward user B, followed by a vertical traversal from user B toward user A's level at E (−1) are needed to get from nodes A to E. This indicates that users A and E are very similar with a summed distance value of 1 (+2−1=1). This equates to an organizational similarity value of 1 (similarity=1/1).

Contextual similarity may be based on the concept that another user that fulfilled the same roles in tasks and workflows is likely to have similar needs and preferences, that users that have generated or consumed similar content are likely to have similar needs and preferences, and the like. To determine contextual similarity, it may be determined if the users have collaborated in the same workspace or on the same workflow, utilized the same content, and the like. For example, a user's profile may include content, users, workflows, workspaces, and the like that the user has interacted with as well as roles that the user may have filled in the workflows. Using key phrase extraction and information retrieval (IR) techniques, comparisons may be made between profiles of different users. For example, known key phrase extraction techniques, such as the Keyphrase Extraction Algorithm (KEA) (described at http://www.nzdl.org/Kea/) or Apache Tika (described at http://tika.apache.org/), and IR techniques, such as the Vector Space Model (described at http://en.wikipedia.org/wiki/Vector_space_model) or Jaccard Index (described at http://en.wikipedia.org/wiki/Jaccard_index), may be used.

In some examples, the contextual similarity may take into consideration how recently and/or frequently users have interacted in similar workspaces/workflows or interacted with similar content. The frequency and age of collaboration may be factored into the resulting similarity score using a configurable half-life period, as discussed below with respect to preference similarity (e.g., equations 1-5, discussed below).

Preference similarity may be based on the concept that users that have expressed preference for similar items, such as users, content, or workflows, are likely to have similar preferences and needs. To determine a user's preference for an item, collected utilization and ratings information accessed at block 301 from a database similar or identical to database 114 may be used. If a user has expressed a preference for an item, that information may be used. These expressions of preference may take the form of a score (e.g., rating from 1-10) or Boolean value (e.g., like/dislike). To account for the different ways preference may be expressed, these ratings may be converted to a normalized value (e.g., real number in the range [−1 . . . 1] or other similarly scaled values). If, however, a user does not specifically rate an item, the user's preference may be derived from comments made about an item in the system. In this case, sentiment analysis (e.g., described at http://en.wikipedia.org/wiki/Sentiment_analysis) may be used to derive a rating in the range [−1 . . . 1] (or other similarly scaled values). Alternatively or in addition, a user's preference may be inferred from the successful completion of workflows and tasks. The level of preference may be derived for a configurable metric related to the task or workflow. A few such examples are the time required for task completion, final task status, or something derived from the content associated with a task, such as the value of a deal. Note that workflows with a negative outcome may affect the preferences negatively.

In some examples, whether the preference is provided by the user or derived/inferred, the frequency and age of utilization and ratings may be taken into account. In these examples, more recent utilization and/or high-frequency utilization may increase a user's effective preference for an item while old and/or low-frequency utilization may reduce the effective preference. A number of mechanisms for computing this are possible. For example, a configurable half-life period may be used. The algorithm for generating a single preference value may configurable within the system, but one example for calculating a preference is provided by equations 1-5, shown below.

p=((rp*rw)+(up*uw))/2 (1)

rp=r*rd (2)

rd=0.5̂(ra*rh) (3)

up=(1/(u+1))*ud (4)

ud=0.5̂(ua*uh) (5)

In the above equation, “p” represents the final preference value in the range [−1 . . . 1] (or other similarly scaled values), “rp” represents the normalized user preference after the value has been decayed, “rw” represents the rating preference weight coefficient, “up” represents the normalized utilization preference after the value has been decayed, “uw” represents the utilization preference weight coefficient, “r” represents the rating value provided by the user in the range [−1 . . . 1] (or other similarly scaled values), “rd” represents the calculated user rating decay coefficient, “ra” represents the age of the most recent user rating (units may be configurable), “rh” represents the configured constant half-life of user ratings, “u” represents the user utilization count for a given item in the range [1 . . . n] (or other similarly scaled values), “ud” represents the calculated utilization decay coefficient, “ua” represents the age of the most recent user utilization (units may be configurable), and “uh” represents the configured constant half-life of user utilization ratings.

In some examples, the above or other algorithms may be used to calculate a preference score for a user. The preference score may be calculated for a user's preference for other users, content, workflows, and the like. Preferences may be computed on a per-user/per-type basis. This may result in an ordered list of the top preference items and a preference value being identified for each user. Each preference may be represented as a real number preference value in the range [−1 . . . 1] (or other similarly scaled values). In addition, mode information associated with each utilization may be stored with the computed preference. The number of top preferences retained per user may be configurable for performance reasons.

It should be appreciated that there are a number of different mechanisms that may be used to compute the similarity between two users. Each individual mechanism used to calculate the various user similarities (e.g., social similarity, organizational similarity, contextual similarity, and preference similarity) may return a user-to-user similarity matrix containing a real number similarity rating in the range [0 . . . 1] (or other similarly scaled values). The results from each mechanism may be combined into a single user/user similarity matrix with a similarity rating as a real number value in the range [0 . . . 1] (or other similarly scaled values). Similarity metrics may be combined using configurable weights.

In some examples, block 303 may be performed after receiving a request for a recommendation at block 201, or may be pre-computed (e.g., using process 600, described below) at some other designated time (e.g., when a user is added, periodically, when contextual data changes, etc.). Using the determined user similarities, an ordered list of the most similar users may be stored (e.g., in database 114) for each user. The size of this list may be configurable to any desired size.

At block 305, task similarity may be determined between a task to be completed by a user and tasks associated with the workflow data. For example, the request for a recommendation received at block 201 may be received from a user attempting to complete a particular task. This task may be compared to task data included within the workflow data accessed at block 301. Task similarity may be based on the concept that a task may be compared for similarity along a number of axes. The task data may include data identifying a workflow from which the task is derived, users that the task is assigned to, users issuing the task, content associated with the task, and the like. Tasks derived from the same workflow, initiated by similar users, assigned to similar users, having similar content, may be determined to be similar. Thus, to determine task similarity, known key phrase extraction techniques, such as the Keyphrase Extraction Algorithm (KEA) (described at http://www.nzdl.org/Kea/) or Apache Tika (described at http://tika.apache.org/), and IR techniques, such as the Vector Space Model (described at http://en.wikipedia.org/wiki/Vector_space_model) or Jaccard Index (described at http://en.wikipedia.org/wiki/Jaccard_index), may be used on the task data. In some examples, similarity scores returned by these techniques for each axis of similarity (e.g., workflow, issuing user, assigned users, content, etc.) may be combined (e.g., a weighted average) into a single notion of similarity between two tasks.

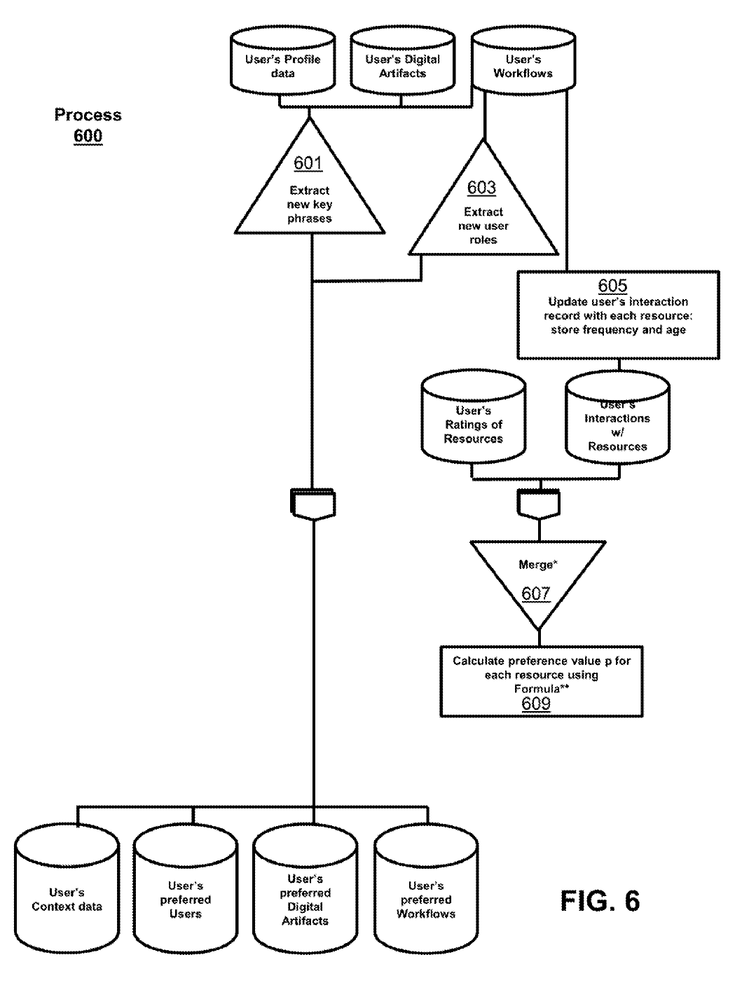

In some examples, similar to block 303, block 305 may be performed after receiving a request for a recommendation at block 201, or may be pre-computed at some other designated time (e.g., when a task is added, a task is modified, content changes, periodically, etc.). Using the determined task similarities, an ordered list of the most similar tasks may be stored (e.g., in database 114) for each task. The size of this list may be configurable to any desired size. For example, process 600 of FIG. 6 may be performed to extract and aggregate preference data. At block 601, new key phrases may be extracted from user profile data, user digital artifacts, and user workflows. At block 603, new user roles may be extracted from user workflows. At block 605, user interaction records with each item may be updated. This may include updating the frequency and age of the interactions. This may be merged with user ratings (preferences) of the items at block 607 and used to calculate preference values using equations 1-5 at block 609. Based on blocks 601, 603, 605, 607, and 609, the user context data, the preferred users, the preferred digital artifacts, and the preferred workflows of the user may be updated.

At block 307, goal similarity may be determined between a goal of a user and goals associated with the workflow data. Goal similarity may be determined, for example, by comparison between the keywords associated with pairs of tasks to be completed. For example, the request for a recommendation received at block 201 may be received from a user attempting to accomplish a particular goal. This goal may be compared to goal data included within the workflow data accessed at block 301. Goal similarity may include, for example, the concept that a goal may be compared for similarity along a number of axes. Thus, to determine goal similarity, known key phrase extraction techniques, such as the Keyphrase Extraction Algorithm (KEA) (described at http://www.nzdl.org/Kea/) or Apache Tika (described at http://tika.apache.org/), and IR techniques, such as the Vector Space Model (described at http://en.wikipedia.org/wiki/Vector_space_model) or Jaccard Index (described at http://en.wikipedia.org/wiki/Jaccard_index), may be used on the goal data. In some examples, similarity scores returned by these techniques for each axis of similarity may be combined (e.g., a weighted average) into a single notion of similarity between two goals.

In some examples, block 307 may be performed after receiving a request for a recommendation at block 201, or may be pre-computed (e.g., using process 600) at some other designated time (e.g., when a goal is added, a goal is modified, periodically, etc.). Using the determined goal similarities, an ordered list of the most similar goals may be stored (e.g., in database 114) for each goal. The size of this list may be configurable to any desired size.

While blocks of process 300 are shown and described in a particular order, it should be appreciated that the blocks may be performed in any order and not all blocks need be performed.

Returning to process 200 of FIG. 2, after determining user and contextual similarity at block 203 (or after block 201 if block 203 was pre-computed), the process may proceed to block 205.

At block 205, the n most similar users may be identified. This may be based on the user similarity determined at block 303 of process 300. For example, block 303 of process 300 may generate an ordered list of users based on their similarity to the user requesting the recommendation at block 201. Based on this list, the n most similar users may be identified. The value n represents a configurable value that may be any value. In some examples, n may default to 20.

At block 207, preferred items of the n most similar users identified at block 205 may be determined. In some examples, the preferred items may include any type of item, such as workflows, users, contacts, tasks, documents, forms, calendar entries, conference rooms, etc. The possible set types may or may not be predetermined. In other examples, the preferred items may be limited to a subset of item types based on input from the user or may be provided on behalf of the user without the user's knowledge based on the context of the user at the time the request is made. For example, if an application on the user's computing device uses the recommendation system to recommend users to assign a task to, then the application may request a recommendation for the type “user.” The preferred items may be taken from the ordered list of each similar user's list of preferred items that may be stored in database 114.

At block 209, the lists of preferred items determined at block 207 may be merged into a single ordered list by merge-sorting each similar user's list of preferred items based on the preference values. Duplicates may optionally be removed, retaining only the most preferred items.

At block 211, additional items may be determined based on context. This may be based on the task similarity determined at block 305 and the goal similarity determined at block 307 of process 300. The requesting user's context may be retrieved, and that context, along with any per-request context (e.g., search criteria), may be used to search items in database 114. The result of block 211 may include one or more ordered lists of items matching or similar to the search criteria (if provided) derived from the user. For example, a list of similar tasks and a list of similar goals determined at blocks 305 and 307, respectively, may be produced by block 211. In some examples, items that are related to or similar to these items may also be returned. Each item in the lists may include a similarity score in the range [0 . . . 1] (or other similarly scaled values).

At block 213, the lists of items determined at block 211 may be merged into a single ordered list by merge-sorting each list of similar context items. Duplicates may optionally be removed, retaining only the most similar items.

At block 215, the merged and sorted lists from blocks 213 and 209 may be merged into a single ordered list by merge-sorting each list of similar context items. Duplicates may optionally be removed, retaining only the most similar. The final score of a recommended item may include a weighted average of the scores from similar users and the contextual search from blocks 209 and 213. If a given item in one input list is not represented in the other input list, then that score may be assumed to be 0. The weighting between the two mechanisms may be a configuration option of the system.

At block 217, a set of recommendations may be generated and returned to the user. The set of recommendations may include the merge and sorted recommended items generated at block 215. For example, a computing device (e.g., server 110) may transmit some or all of the set of recommended items to a computing device associated with the user (e.g., computing device 102, 104, or 106) via a network (e.g., network 108). In some examples, each item in the list may include an identifier, name, and score. The identifier may include the system identifier for the recommended item. This may generally be hidden from the user and used by the application when the item is selected. The name may include a user-visible name of an item that may be displayed in a user interface. The score may include a numerical representation of the strength of the recommendation. For example, items with higher scores may be more highly recommended. Recommendation scores may be computed for each recommendation request and may only have meaning as a relative value within the result list.

The following examples are provided to illustrate the operation of processes 200 and 300. As such, it should be appreciated that the example uses only the amount of data necessary for demonstration purposes. In a real-world example, there could be much more information to process.

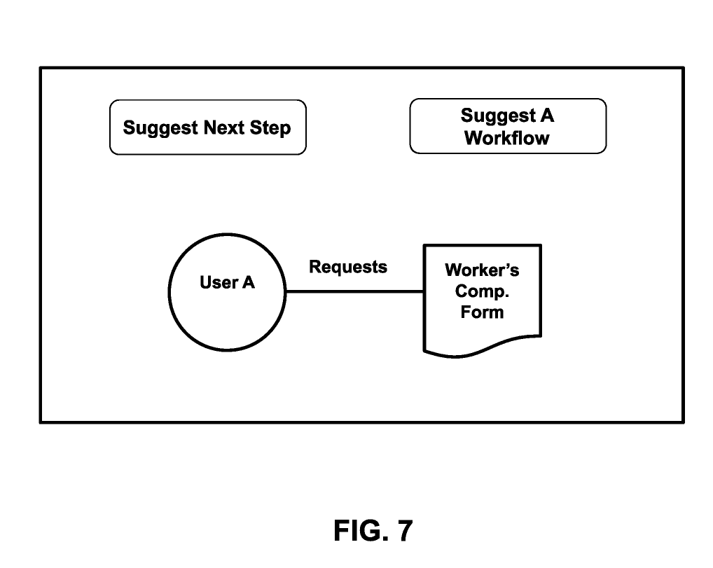

In the first example, User A has been injured at the workplace and wants to get paid worker's compensation. In this example, User A is the user and obtaining worker's compensation is the goal. To accomplish this goal, User A has a vague idea that he needs to get at least one form approved, but does not know which forms to get, where to find them, or who needs to sign them. Among the list of documents available in the Human Resources portal accessible by a workflow management application on his computing device may be one labeled “Worker's Compensation.” In response to User A requesting the document, the workflow application may cause a display of a workflow (e.g., as shown in FIG. 7).

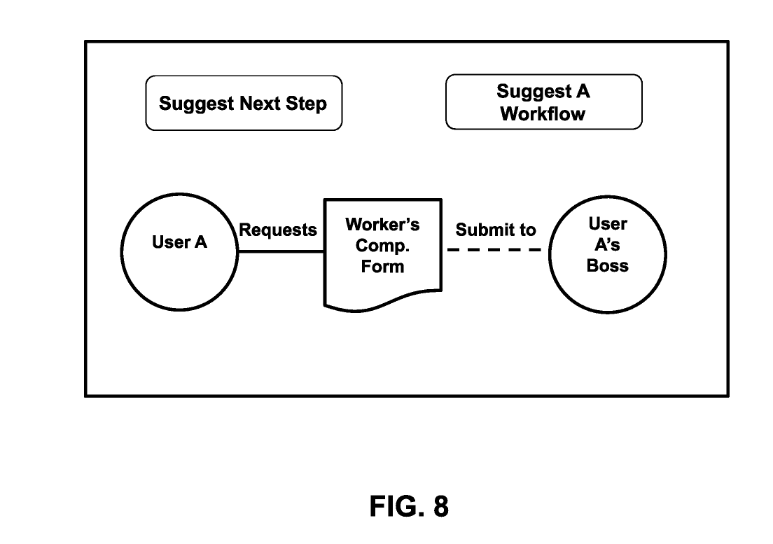

In this example, User A found the correct document, but now he needs to know where to send it. To determine the destination of the document, User A may click on the workflow application's “Suggest Next Step” button shown in FIG. 7. In response to a selection of the “Suggest Next Step” button, server 110 may begin performing process 200. In particular, processes 200 and 300 may be performed to identify other users similar to User A that have previously requested the same form. Server 110 may find that other users most similar to User A requesting the same form all submitted it to the person in the organizational chart who is their supervisor or boss. Server 110 may thus recommend that User A submit the form to his boss (e.g., as shown in FIG. 8).

In another example, instead of selecting the “Worker's Compensation” form, User A is presented with document A and document B but does not know which one to select. In this example, User A may request a recommendation from system 100. To generate this recommendation using processes 200 and 300, described above, equations 1-5 may be performed. At User A's particular company, the half-life of a document may be configured to be 24 months (e.g., after 24 months, half of its value is lost). Throughout this example, the unit of time may be a month (considered to be 30 days). Using this information, the variable “rh” may be equal to 24 (the configured constant half-life of user ratings) and the variable “uh” may be equal to 24 (the configured constant half-life of user utilization ratings). Additionally, the decay coefficient (or decay constant) may be, in half-life terminology, calculated as the natural log of 2 divided by the half-life (in this example, 24). This may provide the calculated quantities “rd” equal to 0.029 and “ud” equal to 0.029.

Further, in this example, it may have been determined that four months ago, User B rated document A at 8 out of 10 stars, and six months ago, User C rated document B at 6 out of 10 stars. To use these values in equations 1-5, they may be normalized to a value within the range of [−1 . . . 1] (or other similarly scaled values), where zero stars is equal to −1 and 10 stars is equal to 1.0. Thus, the 6 stars may be normalized to 0.2 while the 8 stars becomes normalized to 0.6. Additionally, document A may have been accessed three times and document B may have been accessed two times. All three accesses of document A may have been four months ago. One access of document B may have been six months ago while the other occurred 2 months ago. Given this activity, the following may be quantified for documents A and B:

| | A | B | |
|---|---|---|---|
| r | 0.6 | 0.2 | Rating value provided by the user in the range [−1 . . . 1] |
| | | | (or other similarly scaled values). |
| ra | 4 | 6 | Age of the most recent user rating. Units are |
| | | | configurable. |
| u | 3 | 2 | User utilization count for a given item in the range |
| | | | [1 . . . n] (or other similarly scaled values). |
| ua | 4 | 2 | Age of the most recent user utilization. Units are |
| | | | configurable. |

Using equations 2-5, these variables may be calculated to be:

| | A | B | |
|---|---|---|---|
| rp | 0.017 | 0.066 | Normalized user preference after the value has been |
| | | | decayed. |
| rw | 0.891 | 0.841 | Rating preference weight coefficient. |
| up | 0.224 | 0.298 | Normalized utilization preference after the value has |
| | | | been decayed. |
| uw | 0.891 | 0.944 | Utilization preference weight coefficient. |

The final preference value may be determined using equation 1. The resulting preferences based on the values above are A=0.107 and B=0.009. Thus, document A may be preferred over document B.

In another example, User A may have the same problem and knowledge discussed above, but instead of clicking “Suggest Next Step,” User A may select “Suggest a Workflow” in the interface of FIG. 7. In response to the selection, server 110 may begin performing process 200. In particular, processes 200 and 300 may be performed to identify other users similar to User A that have previously requested the same form. Server 110 may further evaluate other workflows and, based on similarities, display several potential workflows that represent the paths others took in the same situation. These workflows may include steps and concepts that User A was unaware of, including:
requesting the Patient's Bill of Rights document
that his supervisor needs to notify the company's insurer
that the insurer must accept the claim
that the insurer will instruct User A to see a doctor
that User A schedule this appointment
that User A attend this appointment
that the doctor may recommend treatment from a therapist
that User A schedule this appointment
that User A get this therapy
that User A schedule a follow-up appointment with the doctor
that User A attend this appointment
that the doctor notify the insurer that the patient has been discharged

User A may now have a better idea of what to do next, what future steps he will need to take, what unexpected events may occur along the way (e.g., therapy), how long it all may take, etc.

Using the processes provided above, recommendations may be generated based on user similarities and contextual similarities. In particular, collaborative filtering, key phrase extraction, and IR techniques may be used. This advantageously allows the system to make recommendations based on various types of data, resulting in the production of recommendations when certain types of data are unavailable. Additionally, the system may provide recommendations for items already known to the user. This allows the system to provide a recommendation for an item that the user interacted with before but may be unaware could be useful in a particular context.

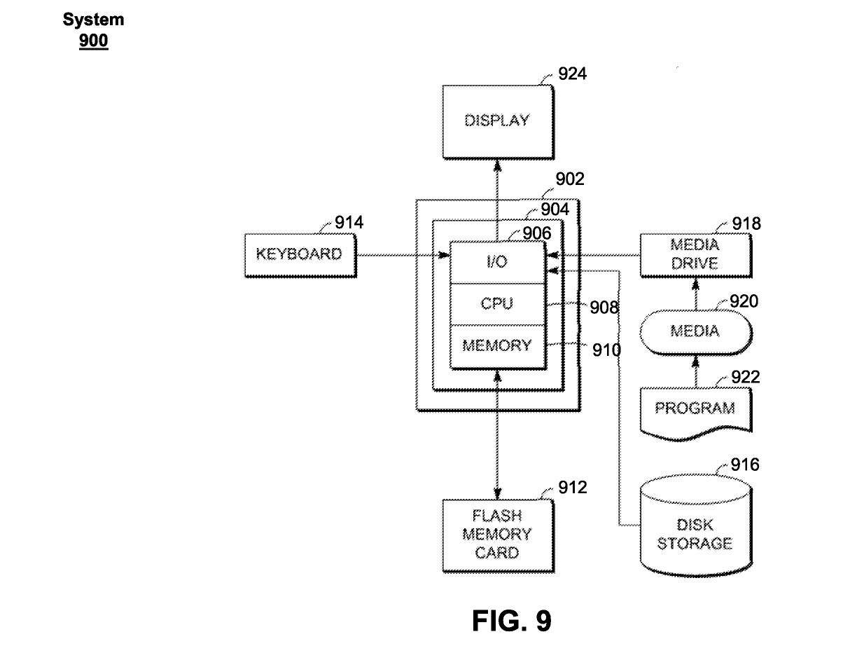

FIG. 9 depicts an exemplary computing system 900 configured to perform any one of the above-described processes. In this context, computing system 900 may include, for example, a processor, memory, storage, and input/output devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform the above-described processes. The main system 902 includes a motherboard 904 having an input/output (“I/O”) section 906, one or more central processing units (CPUs) 908, and a memory section 910, which may have a flash memory card 912 related to it. The I/O section 906 is connected to a display 924, a keyboard 914, a disk storage unit 916, and a media drive unit 918. The media drive unit 918 may read/write a computer-readable medium 920, which may contain programs 922 and/or data.

At least some values based on the results of the above-described processes may be saved for subsequent use. Additionally, a non-transitory computer-readable medium may be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Although only certain exemplary embodiments have been described in detail above, those skilled in the art will readily appreciate that many modifications are possible in the exemplary embodiments without materially departing from the novel teachings and advantages of the present disclosure. For example, aspects of embodiments disclosed above may be combined in other combinations to form additional embodiments. Accordingly, all such modifications are intended to be included within the scope of the present disclosure.

What is claimed is:

1. A computer-implemented method for generating workflow recommendations for a user, the method comprising:
receiving, from a computing device of a user, a request for a recommendation;
determining a plurality of user similarity scores between the user and a plurality of users;
determining a plurality of contextual similarity scores between a context of the user and a context of a plurality of items;
determining a first set of recommended items based on the plurality of user similarity scores;
determining a second set of recommended items based on the plurality of contextual similarity scores;
generating an aggregated set of recommended items based on the first set of recommended items and the second set of recommended items; and
transmitting, to the computing device of the user, the set of aggregated recommended items.

2. The computer-implemented method of claim 1, wherein determining the plurality of user similarity scores is based on one or more of a social graph and an organization graph.

3. The computer-implemented method of claim 1, wherein determining the first set of recommended items based on the plurality of user similarity scores comprises:
generating a ranked list of the plurality of users based on the plurality of user similarity scores;
identifying a subset of similar users based on the ranked list of the plurality of users;
for each user of the subset of similar users, identifying a list of preferred items for that user;
merging and ranking items in the lists of preferred items into a first combined list of preferred items; and
determining the first set of recommended items based on the first combined list of preferred items.

4. The computer-implemented method of claim 1, wherein determining the plurality of contextual similarity scores between the context of the user and the context of the plurality of items comprises:
determining a task similarity score between a task to be completed by the user and each task of the plurality of items; and
determining a goal similarity score between a goal of the user and each goal of the plurality of items.

5. The computer-implemented method of claim 4, wherein determining the task similarity score comprises comparing an associated workflow, an initiating user, an assignment, or an associated content of the task to be completed by the user with an associated workflow, an initiating user, an assignment, and an associated content of each task of the plurality of items.

6. The computer-implemented method of claim 4, wherein determining the goal similarity score comprises performing an information retrieval operation on the goal of the user and the goal associated with each goal of the plurality of items.

7. The computer-implemented method of claim 4, wherein determining the second set of recommended items based on the plurality of contextual similarity scores comprises:
generating a ranked list of the plurality of items based on the task similarity scores and the goal similarity scores; and
determining the second set of recommended items based on the ranked list of the plurality of items.

8. The computer-implemented method of claim 1, wherein generating the aggregated set of recommended items based on the first set of recommended items and the second set of recommended items comprises:
merging and ranking items in the first set of recommended items and the second set of recommended items into a second combined list of preferred items; and
generating the aggregated set of recommended items based on the second combined list of preferred items.

9. The computer-implemented method of claim 1, wherein merging and ranking items in the first set of recommended items and the second set of recommended items into the second combined list of preferred items comprises:
determining a weighted average of scores of the items in the first set of recommended items and scores of the items in the second set of recommended items; and
ranking the items of the first set of recommended items and the second set of recommended items based on the determined weighted average scores.

10. The computer-implemented method of claim 1, wherein the aggregated set of recommended items comprises a recommended document, a recommended task, a recommended workflow, or an identification of a recommended user.

11. A non-transitory computer-readable storage medium comprising computer-executable instructions for generating workflow recommendations for a user, the computer-executable instructions comprising instructions for:
receiving, from a computing device of a user, a request for a recommendation;
determining a plurality of user similarity scores between the user and a plurality of users;
determining a plurality of contextual similarity scores between a context of the user and a context of a plurality of items;
determining a first set of recommended items based on the plurality of user similarity scores;
determining a second set of recommended items based on the plurality of contextual similarity scores;
generating an aggregated set of recommended items based on the first set of recommended items and the second set of recommended items; and
transmitting, to the computing device of the user, the set of aggregated recommended items.

12. The non-transitory computer-readable storage medium of claim 11, wherein determining the plurality of user similarity scores is based on one or more of a social graph and an organization graph.

13. The non-transitory computer-readable storage medium of claim 11, wherein determining the first set of recommended items based on the plurality of user similarity scores comprises:
generating a ranked list of the plurality of users based on the plurality of user similarity scores;
identifying a subset of similar users based on the ranked list of the plurality of users;
for each user of the subset of similar users, identifying a list of preferred items for that user;
merging and ranking items in the lists of preferred items into a first combined list of preferred items; and
determining the first set of recommended items based on the first combined list of preferred items.

14. The non-transitory computer-readable storage medium of claim 11, wherein determining the plurality of contextual similarity scores between the context of the user and the context of the plurality of items comprises:
determining a task similarity score between a task to be completed by the user and each task of the plurality of items; and
determining a goal similarity score between a goal of the user and each goal of the plurality of items.

15. The non-transitory computer-readable storage medium of claim 14, wherein determining the task similarity score comprises comparing an associated workflow, an initiating user, an assignment, or an associated content of the task to be completed by the user with an associated workflow, an initiating user, an assignment, and an associated content of each task of the plurality of items.

16. The non-transitory computer-readable storage medium of claim 14, wherein determining the goal similarity score comprises performing an information retrieval operation on the goal of the user and the goal associated with each goal of the plurality of items.

17. The non-transitory computer-readable storage medium of claim 14, wherein determining the second set of recommended items based on the plurality of contextual similarity scores comprises:
generating a ranked list of the plurality of items based on the task similarity scores and the goal similarity scores; and
determining the second set of recommended items based on the ranked list of the plurality of items.

18. The non-transitory computer-readable storage medium of claim 11, wherein generating the aggregated set of recommended items based on the first set of recommended items and the second set of recommended items comprises:
merging and ranking items in the first set of recommended items and the second set of recommended items into a second combined list of preferred items; and
generating the aggregated set of recommended items based on the second combined list of preferred items.

19. The non-transitory computer-readable storage medium of claim 11, wherein merging and ranking items in the first set of recommended items and the second set of recommended items into the second combined list of preferred items comprises:
determining a weighted average of scores of the items in the first set of recommended items and scores of the items in the second set of recommended items; and
ranking the items of the first set of recommended items and the second set of recommended items based on the determined weighted average scores.

20. The non-transitory computer-readable storage medium of claim 11, wherein the aggregated set of recommended items comprises a recommended document, a recommended task, a recommended workflow, or an identification of a recommended user.

21. An apparatus for generating workflow recommendations for a user, the apparatus comprising:
a memory comprising computer-executable instructions for:
receiving, from a computing device of a user, a request for a recommendation;
determining a plurality of user similarity scores between the user and a plurality of users;
determining a plurality of contextual similarity scores between a context of the user and a context of a plurality of items;
determining a first set of recommended items based on the plurality of user similarity scores;
determining a second set of recommended items based on the plurality of contextual similarity scores;
generating an aggregated set of recommended items based on the first set of recommended items and the second set of recommended items; and
transmitting, to the computing device of the user, the set of aggregated recommended items; and
a processor for executing the computer-executable instructions.

22. The apparatus of claim 21, wherein determining the plurality of user similarity scores is based on one or more of a social graph and an organization graph.

23. The apparatus of claim 21, wherein determining the first set of recommended items based on the plurality of user similarity scores comprises:
generating a ranked list of the plurality of users based on the plurality of user similarity scores;
identifying a subset of similar users based on the ranked list of the plurality of users;
for each user of the subset of similar users, identifying a list of preferred items for that user;
merging and ranking items in the lists of preferred items into a first combined list of preferred items; and
determining the first set of recommended items based on the first combined list of preferred items.

24. The apparatus of claim 21, wherein determining the plurality of contextual similarity scores between the context of the user and the context of the plurality of items comprises:
determining a task similarity score between a task to be completed by the user and each task of the plurality of items; and
determining a goal similarity score between a goal of the user and each goal of the plurality of items.

25. The apparatus of claim 24, wherein determining the task similarity score comprises comparing an associated workflow, an initiating user, an assignment, or an associated content of the task to be completed by the user with an associated workflow, an initiating user, an assignment, and an associated content of each task of the plurality of items.

26. The apparatus of claim 24, wherein determining the goal similarity score comprises performing an information retrieval operation on the goal of the user and the goal associated with each goal of the plurality of items.

27. The apparatus of claim 24, wherein determining the second set of recommended items based on the plurality of contextual similarity scores comprises:
generating a ranked list of the plurality of items based on the task similarity scores and the goal similarity scores; and
determining the second set of recommended items based on the ranked list of the plurality of items.

28. The apparatus of claim 21, wherein generating the aggregated set of recommended items based on the first set of recommended items and the second set of recommended items comprises:
merging and ranking items in the first set of recommended items and the second set of recommended items into a second combined list of preferred items; and
generating the aggregated set of recommended items based on the second combined list of preferred items.

29. The apparatus of claim 21, wherein merging and ranking items in the first set of recommended items and the second set of recommended items into the second combined list of preferred items comprises:
determining a weighted average of scores of the items in the first set of recommended items and scores of the items in the second set of recommended items; and
ranking the items of the first set of recommended items and the second set of recommended items based on the determined weighted average scores.

30. The apparatus of claim 21, wherein the aggregated set of recommended items comprises a recommended document, a recommended task, a recommended workflow, or an identification of a recommended user.
